(19) United States
(12) Patent Application Publication
(10) Pub. No.: US 2007/0078206 A1
(43) Pub. Date: Apr. 5, 2007

(54) Sound damping composition

(76) Inventor: David John St. Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 11/243,269

(22) Filed: Oct. 4, 2005

(51) Int. Cl. C08K 5/00

(52) U.S. Cl. 524/287

(57) ABSTRACT

A sound damping composition which includes a plasticizer and at least one unsaturated block copolymer having a mono alkenyl arene content of equal to or greater than 60 weight percent and a modulus of less than 125,000 psi. The plasticizer is an aromatic ester or a liquid aromatic resin. The sound damping composition is characterized by having improved sound damping characteristics over sound damping composition employing block copolymers containing conjugated diene homopolymer elastomeric blocks.

### FIELD OF THE INVENTION

The present invention is directed to an improved sound damping composition useful in absorbing sound waves that includes an aromatic plasticizer and at least one block copolymer. More specifically, the present invention is directed to a sound damping composition in which the block copolymer is an unsaturated block copolymer having a high monoalkenyl arene content and a modulus of less than 125,000 psi.

### BACKGROUND OF THE INVENTION

Many types of materials are utilized as sound damping compositions. The types of material employed vary widely with the sound damping application and the sound frequencies which are to be damped. Although there are a multiplicity of applications and specific sound waves to be damped, it is generally the case that materials which effectively dampen sound are relatively soft and inelastic. Soft and inelastic materials are readily deformed by sound waves but that deformation is absorbed by inelastic deformation of the material.

Although the sound damping effectiveness of a material must be measured by equipment designed to test the material's effectiveness in a specific application, estimates of a material's sound damping effectiveness can be obtained by dynamic mechanical analysis (DMA). DMA measures a material's properties under low strain, oscillatory deformation. DMA establishes that materials having good sound damping properties are those which have a relatively high value of tan δ over as broad a frequency range as possible. Tan δ is defined as the ratio of loss modulus, G″, to elastic modulus, G′.

For ease of analysis, tan δ is measured as a function of temperature, rather than frequency, although tan δ as a function of sound wave frequency is information that a sound designer must possess. Fortunately, a tan δ vs. temperature curve can be converted to a tan δ vs. frequency curve at a chosen temperature by use of the Williams Landel Ferry (WLF) Equation, as set forth in J. Am. Chem. Soc., 77, 3701 (1955), incorporated herein by reference.

Suffice it to say, the sound damping properties of a material are deemed superior when the material's tan δ is relatively high, e.g., about 1.0, over a broad temperature range. Thus, when a material is required to dampen sound at ambient temperature, e.g., about 25° C., it should possess a complex modulus, G*, which is \sqrt{(G′)²+(G″)²}, of from about 1.0 to about 20 MPa at 25° C. A material possessing this complex modulus range is reasonably flexible. Moreover, if the sound damping material is applied as a hot melt, it should have a melt viscosity below about 50 Pa·s at 175° C. to effectuate easy application. Of course, if the material is to be extruded as a sheet or extruded onto a carrier, its viscosity can be much higher.

The use of block copolymers as sound damping agents is known in the art. A block copolymer constituent, for example, is utilized in a bituminous composition, used as a sound and vibration damping agent, as set forth in U.S. Pat. No. 6,508,875.

Although block copolymers have been successfully utilized in sound damping compositions, the above remarks make it apparent that not all block copolymers are suited for sound damping application. This is so in that although a good sound damping material must be soft, as are many block copolymers, block copolymers are usually elastic due to their high concentration of conjugated diene. It is thus apparent that there is a strong need in the art for a new block copolymer-based composition useful as a sound damping material.

### SUMMARY OF THE INVENTION

A sound damping composition has now been developed which provides improved sound damping over sound damping compositions of the prior art which include block copolymers which contain a mono alkenyl arene and a conjugated diene.

The present invention provides a sound damping composition which includes at least one unsaturated block copolymer that has a high monoalkenyl arene content and a modulus of less than 125,000 psi; and a plasticizer selected from the group consisting of aromatic esters and liquid aromatic resins. The at least one unsaturated block copolymer having the high monoalkenyl arene content and modulus of less than 125,000 psi employed in the present invention will be described in greater detail herein below. Throughout this application, the aforementioned block copolymer can also be referred to as ‘an unsaturated high monoalkenyl arene content block copolymer having a modulus of less than 125,000 psi’.

More specifically, the block copolymers of the present invention are unsaturated block copolymers having a monoalkenyl arene (polystyrene) content equal to or greater than about 60 weight percent based on the total weight of the block copolymer and a modulus less than about 125,000 psi. These block copolymers include at least two A blocks and at least one B block, wherein each A block is a mono alkenyl arene homopolymer block and each B block is selected from (a) a polymer block of at least one conjugated diene and at least one mono alkenyl arene and having a random distribution, (b) a polymer block of at least one conjugated diene and at least one mono alkenyl arene and having a blocked distribution; (c) a polymer block of at least one conjugated diene and at least one mono alkenyl arene and having a tapered distribution; and (d) a polymer block of at least one conjugated diene and at least one mono alkenyl arene and having a controlled distribution.

It has been discovered that the tendency toward excess elasticity that was detrimental to the use of block copolymers in the past can be eliminated by employing an unsaturated block copolymer having a high monoalkenyl arene content and a modulus of less than 125,000 psi. Since the monomers used in forming the unsaturated high monoalkenyl arene content block copolymer having a modulus of less than 125,000 psi are readily available and are reasonably priced, the unsaturated high monoalkenyl arene content block copolymer having a modulus of less than 125,000 psi employed in the present invention can replace conventional block copolymer of the prior art with little or no increase in cost.

### BRIEF DESCRIPTION OF THE INVENTION

The present invention may be better understood by reference to the accompanying drawings of which:

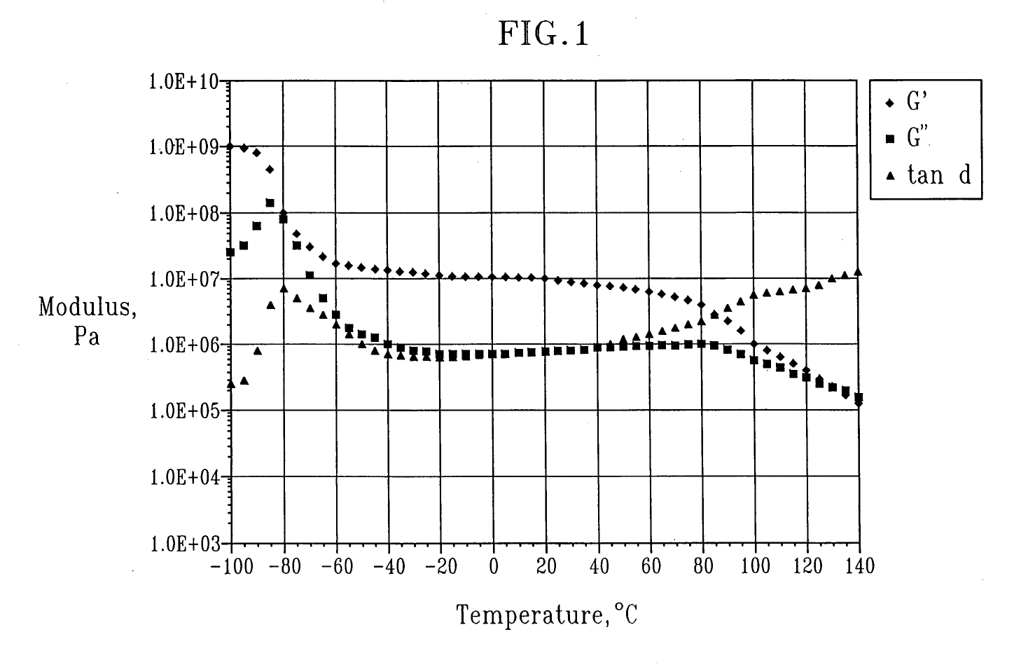

FIG. 1 is a dynamic mechanical analysis (DMA) curve illustrating elastic modulus (G′), loss modulus (G″) and tan δ×10⁷ as a function of temperature for composition CE 1;

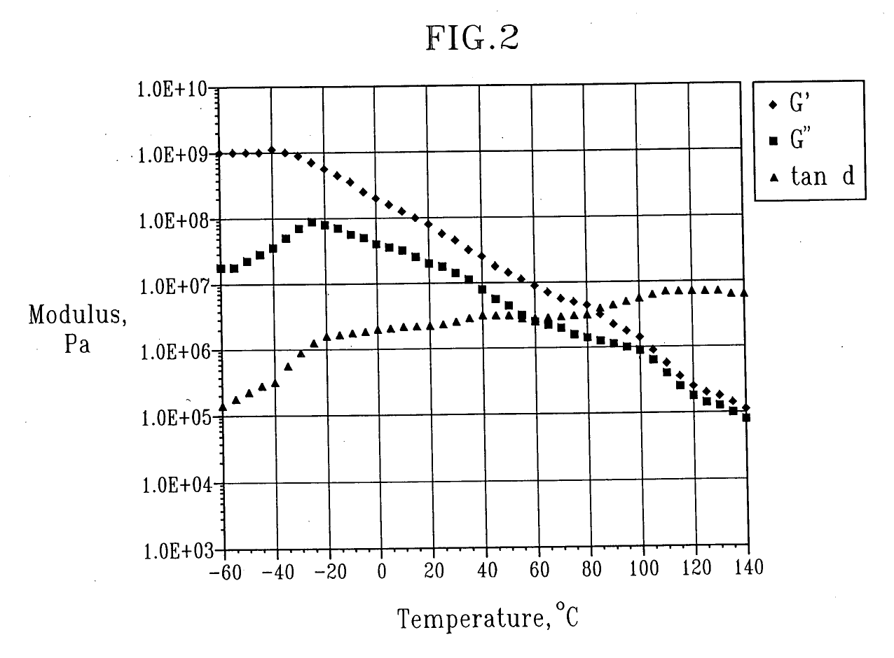

FIG. 2 is a DMA curve depicting G′, G″ and tan δ×10⁷ as a function of temperature for composition CE 2;

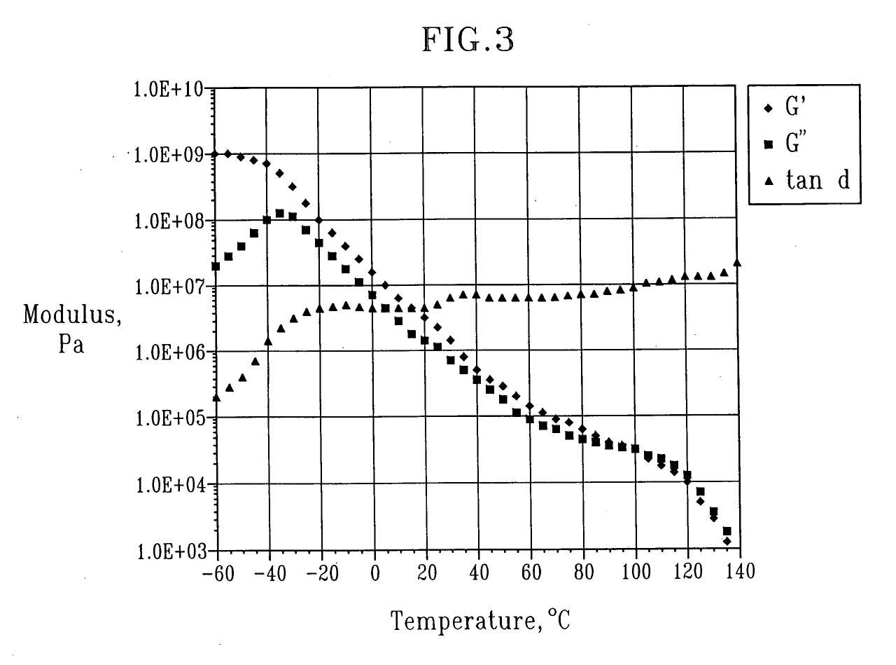

FIG. 3 is a DMA curve depicting G′, G″ and tan δ×10⁷ as a function of temperature for Composition A;

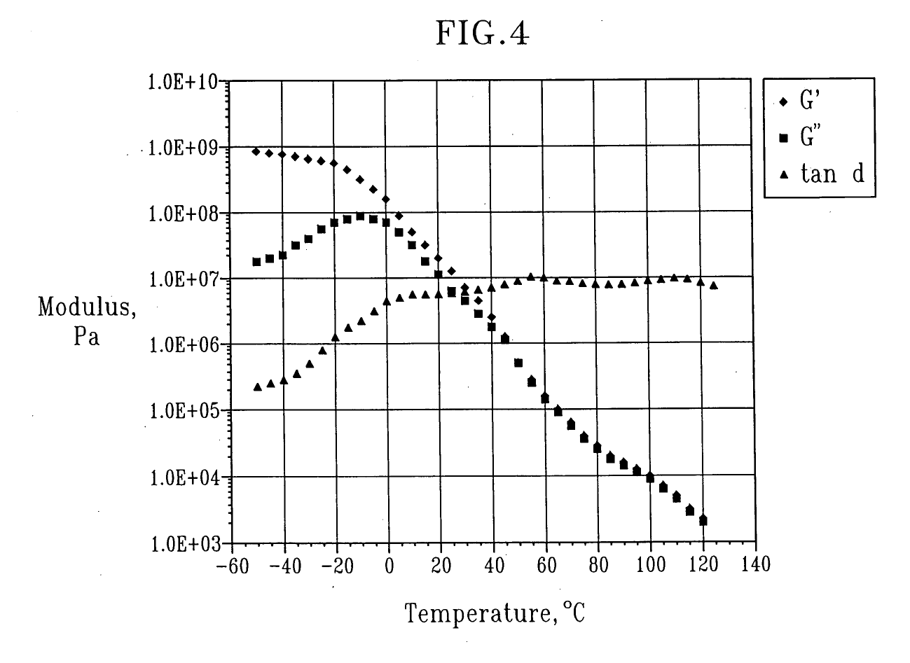

FIG. 4 is a DMA curve illustrating G′, G″ and tan δ×10⁷ as a function of temperature for Composition B;

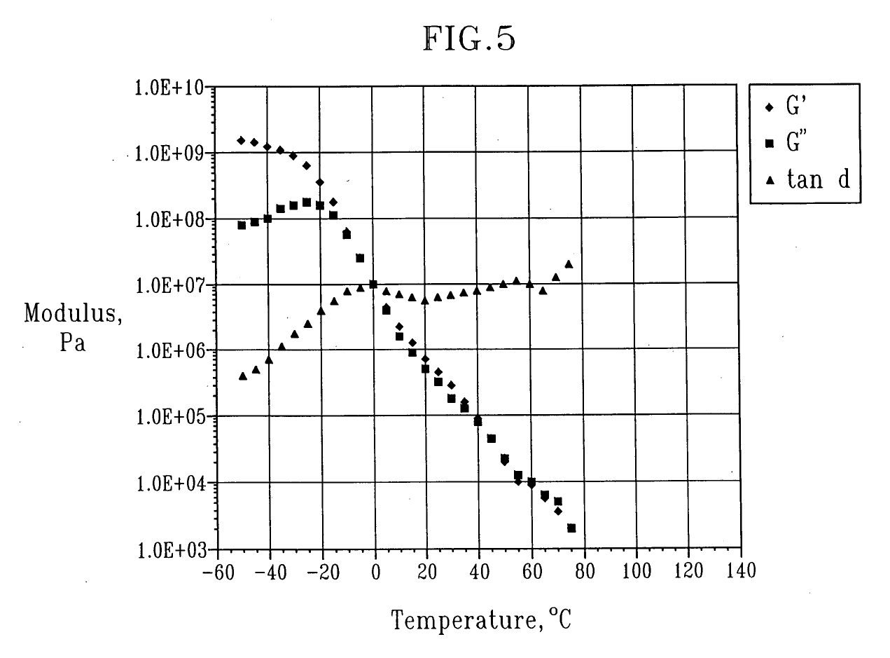

FIG. 5 is a DMA curve depicting G′, G″ and tan δ×10⁷ as a function of temperature for Composition CE 3;

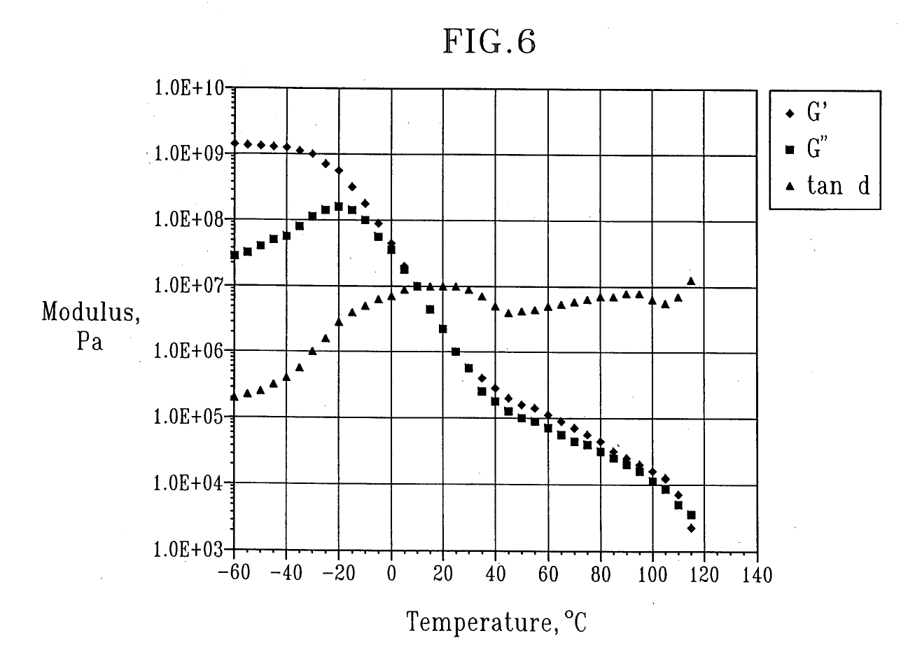

FIG. 6 is a DMA curve depicting G′, G″ and tan δ×10⁷ as a function of temperature for Composition C;

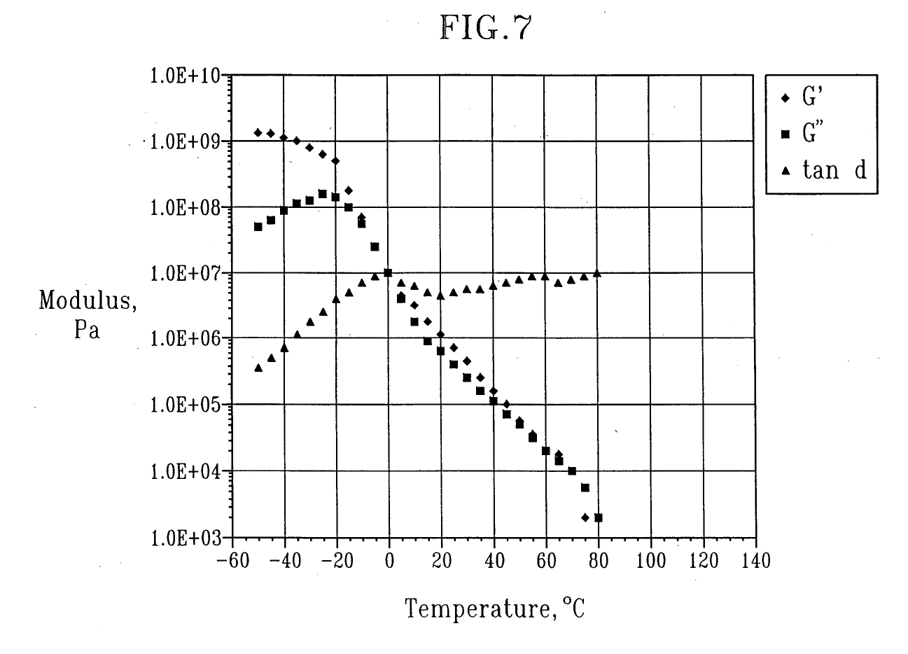

FIG. 7 is a DMA curve depicting G′, G″ and tan δ×10⁷ as a function of temperature for Composition D;

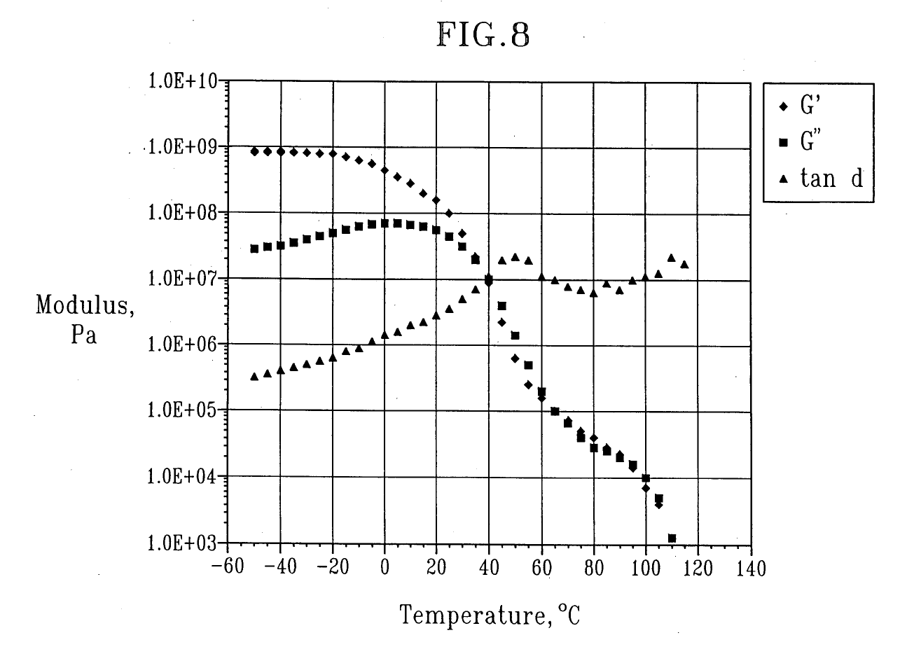

FIG. 8 is a DMA curve depicting G′, G″ and tan δ×10⁷ as a function of temperature for Composition E; and

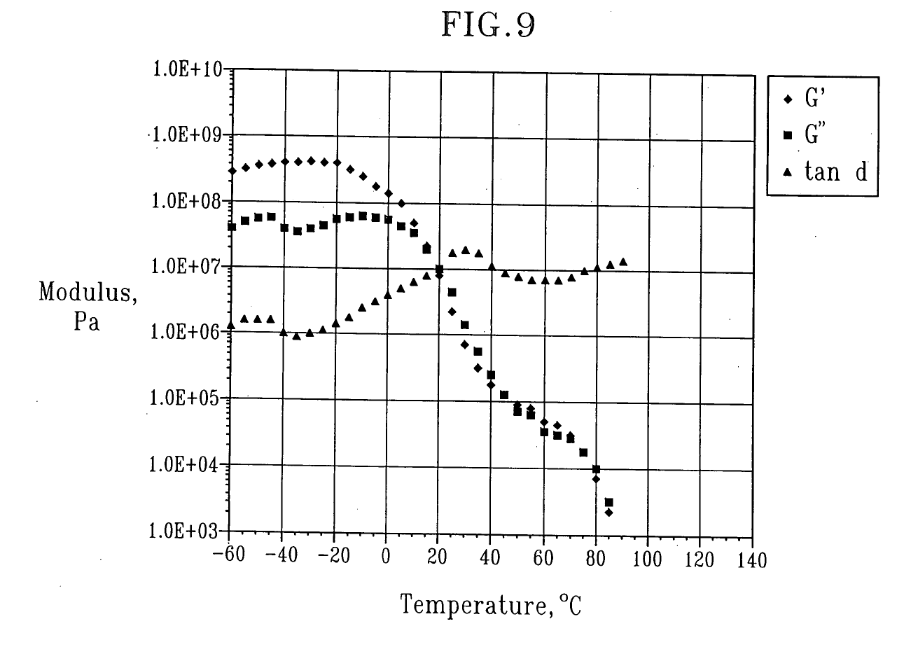

FIG. 9 is a DMA curve depicting G′, G″ and tan δ×10⁷ as a function of temperature for Composition F.

### DETAILED DESCRIPTION OF THE INVENTION

The present invention provides a sound damping composition comprising:

a) at least one unsaturated (i.e., unhydrogenated) block copolymer; and

b) a plasticizer selected from the group consisting of an aromatic ester and a liquid aromatic resin.

Specifically, the block copolymers utilized in the present invention broadly comprise any unsaturated block copolymers that meet the following criteria:
(1) the block copolymer has a mono alkenyl arene content equal to or greater than 60 weight percent, based on the total weight of the block copolymer;
(2) the block copolymer has a modulus less than about 125,000 psi; and
(3) the block copolymer has at least two A blocks and at least one B block wherein each A block is a mono alkenyl arene polymer block and wherein each B block is selected from:
   (a) polymer blocks having at least one conjugated diene and at least one mono alkenyl arene and having a random distribution;
   (b) polymer blocks having at least one conjugated diene and at least one mono alkenyl arene and having a blocked distribution;
   (c) polymer blocks having at least one conjugated diene and at least one mono alkenyl arene and having a tapered distribution; and
   (d) polymer blocks having at least one conjugated diene and at least one mono alkenyl arene and having a controlled distribution.

One important aspect of the block copolymers used in preparing the sounding damping composition of the present invention is the mono alkenyl arene content. As noted hereinbefore, the mono alkenyl arene content should be equal to or greater than 60 weight percent, based on the total weight of the block copolymer. Preferably, the mono alkenyl arene content will range from about 60 to about 85 weight percent for the block copolymer. In alternative embodiments, the mono alkenyl arene content will range from about 70 to about 80 weight percent, more preferably from about 73 to about 78 weight percent.

Another important aspect of the block copolymers utilized in the present invention is the modulus of the block copolymer. As used herein, the term “modulus” refers to flexural modulus according to ASTM D-790 (Procedure B). This modulus refers to the ratio of stress to strain for a given polymer. The block copolymers used in the present invention will have a modulus of less than about 125,000 psi. The modulus is preferably less than about 115,000 psi and even more preferably less than about 11 0,000.

The mono alkenyl arenes utilized in the A and B blocks of the block copolymers are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of the block B blocks are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadiene being the more preferred of the two.

While a wide range of molecular weights of the block copolymers utilized in the compositions of the present invention can be used, in many instances the number average molecular weight of each A block will independently range from about 5,000 to about 200,000, preferably from about 7,500 to about 150,000, and the number average molecular weight of each B block will independently range from about 10,000 to about 100,000, preferably from about 10,000 to about 75,000, for the sequential block copolymers and from about 5,000 to about 50,000, preferable from about 5,000 to about 37,500, for the coupled block copolymers.

As noted above, the B block(s) of the block copolymers that can be utilized in the present invention are selected from a variety of midblocks. More specifically, within the scope of the contemplated block copolymers are those block copolymers wherein the midblocks are considered to have a distribution configuration that is “random”, “blocked”, “tapered” or “controlled”.

More specifically, in embodiment (a), B comprises a polymer block of at least one conjugated diene and at least one mono alkenyl arene wherein the B block has a random distribution. As used herein, the phrase “random distribution” means that the distribution of monomers from one end of the block to the other end is roughly uniform (e.g., it is a statistical distribution based on the relative concentrations of the monomers). Preferably, in this embodiment, the conjugated diene of each B block is independently selected from isoprene and butadiene, with butadiene being the most preferred, and the mono alkenyl arene is as defined hereinbefore with regard to A, with styrene be the most preferred.

In the second embodiment (b), B comprises a polymer block comprising at least one conjugated diene and at least one mono alkenyl arene, wherein the B block has a blocked distribution. As used herein, the phrase “blocked distribution” means that the distribution is a nonuniform distribution in which the A monomers (or in the alternative the B monomers) are more likely to be grouped with other A monomers (or in the case of the B monomers, with other B monomers) than is found in a statistical (i.e., “random”) distribution thereby resulting in a short “defined” monomer block. Preferably, in this embodiment, the conjugated diene of each B block is also independently selected from isoprene and butadiene with butadiene being the most preferred and the mono alkenyl arene is as defined hereinbefore with regard to A, with styrene being the most preferred.

In the third embodiment (c), B comprises a polymer block comprising at least one conjugated diene and at least one mono alkenyl arene, wherein the B block has a tapered distribution. As used herein, the phrase “tapered distribution” means that the distribution is a nonuniform distribution in which the concentration of A monomer (or in the alternative, B monomer) at one end of the block is greater than at the other end of the block (it gradually declines from one end of the block to the other end of the block). As in the other embodiments, preferably the conjugated diene of each B block is also independently selected from isoprene and butadiene with butadiene being the most preferred and the mono alkenyl arene is as defined hereinbefore with regard to A, with styrene being the most preferred.

In the fourth and final embodiment (d), B comprises a polymer block comprising at least one conjugated diene and at least one mono alkenyl arene, wherein the B block has a controlled distribution. For purposes herein, the phrase “controlled distribution” is as defined in co-pending and commonly assigned U.S. patent application Ser. No. 10/359,981, filed Feb. 6, 2003 and entitled “NOVEL BLOCK COPOLYMERS AND METHOD FOR MAKING SAME”. The entire contents of the Ser. No. 10/359,981 patent application, are thus incorporated herein by reference. More specifically, the molecular structure of the controlled distribution block copolymer has the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e., having a greater than average amount of) mono alkenyl arene units; and (3) an overall structure having relatively low mono alkenyl arene, e.g., styrene, blockiness. For the purposes hereof, “rich in” is defined as greater than the average amount, preferably 5% greater than the average amount. As in the other embodiments, preferably the conjugated diene of each B block is also independently selected from isoprene and butadiene with butadiene being the most preferred and the mono alkenyl arene is as defined hereinbefore with regard to A, with styrene being the most preferred.

The block copolymers of the present invention may be prepared by any of the methods known in the art, including sequential polymerization and coupling using standard coupling agents. Examples of block copolymers that may be used in the sound damping compositions of the present invention, as well as the methods of preparing such block copolymers, include but are not limited to: polymers and methods disclosed in U.S. Pat. No. 4,925,899, U.S. Pat. No. 6,521,712, U.S. Pat. No. 6,420,486, U.S. Pat. No. 3,369,160, U.S. Pat. No. 6,265,485, U.S. Pat. No. 6,197,889, U.S. Pat. No. 6,096,828, U.S. Pat. No. 5,705,569, U.S. Pat. No. 6,031,053, U.S. Pat. No. 5,910,546, U.S. Pat. No. 5,545,690, U.S. Pat. No. 5,436,298, U.S. Pat. No. 4,248,981, U.S. Pat. No. 4,167,545, U.S. Pat. No. 4,122,134, U.S. Pat. No. 6,593,430, and U.S. patent application Ser. No. 10/359,981, each incorporated herein by reference.

As noted hereinbefore, the block copolymers used in the present invention have at least two A blocks and at least one B block. Accordingly, the block copolymers used in the present invention may comprise any block copolymer which meets the criteria for the present invention, including block copolymers that are linear sequential, as well as block copolymers that are coupled (including linear coupled and branched (multi-arm) coupled block copolymers). When the block copolymer is linear coupled or multi-arm coupled, the arms may be symmetrical or asymmetrical.

While not wishing to be bound by the structure of the present block copolymers, representative structures which contain at least two A blocks and at least one B block and which are considered to be within the scope of the present invention, provided they meet the other criteria noted above, include, but are not limited to, block copolymers of the structure:
(1) (A-A₁-B—C)ₘ—X—(C—B-A₁)ₙ, wherein each A and A₁ is independently a polymer block of mono alkenyl arene, each B is independently a copolymer block of mono alkenyl arene and conjugated diene, each C is independently a block of conjugated diene and m≦n and m+n is 3 to 20.
(2) A₁-B₁—B₂-A₂, wherein each A₁ and A₂ is independently a polymer block of mono alkenyl arene and the each of the B's is independently a polymer block of mono alkenyl arene and conjugated diene.
(3) A-B-A, (A-B)ₙ, (A-B)ₙ-A, (A-B-A)ₙ-X, or (A-B)ₙ—X, wherein each A is independently a polymer block of mono alkenyl arene, each B is independently a polymer block of mono alkenyl arene and conjugated diene, X is the residue of a coupling agent and n is from 2 to 30.
(4) A-A₁-B—B₁—X—B₁—B-A₁-A, A-B—B₁—X—B-A, A-A₁-B—B₁—X—B₁—B-A, wherein each A and A₁ is independently a polymer block of mono alkenyl arene and each B and B₁ is independently a polymer block of mono alkenyl arene and conjugated diene
(5) B-(A-B)ₙ; X-[(A-B)ₙ]ₘ₊₁; X—[(B-A)ₙ]ₘ₊₁; X-[(A-B)ₙ-A]ₘ₊₁; X—[(B-A)ₙ-B)]ₘ₊₁; Y-[(A-B)ₙ]ₘ₊₁; Y—[(B-A)ₙ]ₘ₊₁; Y-[(A-B)ₙ-A]ₘ₊₁; Y—[(B-A)ₙ-B]ₘ₊₁ wherein each A is independently a polymer block of mono alkenyl arene, each B is independently a polymer block of mono alkenyl arene and diene, X is a radical of an n-functional initiator, Y is a radical of an m-functional coupling agent and m and n are natural numbers from 1 to 10.
(6) (A₁-A₂-B₁—B₂—B₃)ₙ—X—(B3—B₂—B₁-A₂)ₘ wherein each A₁ and A₂ is independently a polymer block of mono alkenyl arene, each B₁, B₂ and B₃ is independently a polymer block of mono alkenyl arene and conjugated diene and n and m are each independently 0 or ≧3.
(7) A-A₁-B—X—B-A₁-A, A-B—X—B-A, A-A₁-B—X—B-A wherein each A is independently a polymer block of mono alkenyl arene and each B is independently a polymer block of mono alkenyl arene and conjugated diene.
(8) A₁-B₁—C₁, A₁-C₁—B₁, A₁-B₁—C₁-A₂, A₁-B₁—C₁—B₂-A₂, A₁-C₁—B₁—C₂-A₂, A₁-B₁—B₂—C₁-A₂, A₁-B₁—C₁—B₂—C₂—B₃-A₂, A₁-B₁-A₂-B₂—C₁-A₃, A₁-B₁—C₁-A₂-C₂—B₂-A₃, A₁-B₁-A₂-C₁—B₂, A₁-B₁-A₂-B₂—C₁, wherein each A₁, A₂ and A₃ is independently a mono alkenyl arene, each B₁ and B₂ is independently a polymer block of mono alkenyl arene and conjugated diene and each C₁ and C₂ is independently a polymer block of conjugated diene.

With regard to the above-noted structures specifically made by coupling, those skilled in the art will recognize that these polymers may contain a small amount of diblock (i.e., up to about 10% diblock).

As used herein, in those instances where it is noted that the blocks are “independently” a polymer block, such polymer blocks can be the same, or they can be different.

Also contemplated within this scope are various types of block copolymers that are grafted or functionalized with various functional groups such as unsaturated monomer having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of fuictionalizing such block copolymers can be found in U.S. Pat. No. 4,578,429 and U.S. Pat. No. 5,506,299. In another manner, the copolymers employed in the present invention may be functionalized by grafting silicon or boron-containing compounds to the polymer as taught, for example, in U.S. Pat. No. 4,882,384. In still another manner, the block copolymers of the present invention may be contacted with an alkoxy-silane compound to form silane-modified block copolymer. In yet another manner, the block copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. No. 5,206,300 and U.S. Pat. No. 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

It should be noted that the above-described unsaturated block copolymers used in the present invention may, if desired, be readily prepared by the methods set forth above. However, since many of these copolymers are commercially available, it is usually preferred to employ the commercially available polymer as this serves to reduce the number of processing steps involved in the overall process. Examples of the above block copolymers which are commercially available include, but are not limited to, Styrolux®3G55 (commercially available from BASF Aktiengesellschaft), XK40 (commercially available from Chevron-Phillips Corporation) and KRATON® MD 6459 (commercially available from KRATON Polymers LLC).

The above-discussed copolymers are advantageously employed as a component of the sound damping composition of the present application. Although the invention is independent of any theory explaining its operation, it is believed that the lower conjugated diene concentration of the block or blocks produce a more inelastic constituent without excessively hardening the copolymer thus providing a product having greater sound damping capability than the block copolymers of the prior art that have been previously employed in this application.

The second component of the sound damping composition is a plasticizer. The plasticizer is an aromatic compound selected from the group consisting of an aromatic ester and a liquid aromatic resin. Although independent of any theory explaining its operation, it is believed that inclusion of a plasticizer significantly reduces the complex modulus thus increasing the damping characteristics of the resultant sound damping composition. The plasticizer also reduces the melt viscosity of the composition, making it easier to mix and apply.

In the embodiment wherein the plasticizer is an aromatic ester, the aromatic ester is preferably a benzoate or a phthalate compound. Preferred examples of such esters are butyl benzyl phthalate, 2,2,4-trimethyl pentanediol dibenzoate, and isodecyl benzoate.

A second embodiment of plasticizers of the sound damping composition is liquid aromatic resins. A liquid aromatic resin is a polymer of an aromatic hydrocarbon whose softening point is less than room temperature. A particularly preferred class of the liquid aromatic resins is the class of aromatic resins whose softening point is about 5° C. or lower.

In a preferred embodiment, the sound damping composition includes a third component, a solid aromatic resin or a solid aromatic-modified aliphatic resin. This third component resin is thus a polymer of an aromatic hydrocarbon or a mixture of aromatic and aliphatic hydrocarbons whose softening point is greater than ambient temperature. Both the aromatic resins and the mixed aromatic/aliphatic resins are referred to herein as a solid aromatic resin. They are so characterized in that, just as the aforementioned liquid aromatic resin is a liquid under ambient conditions, the aromatic resin is a solid under ambient conditions. Preferably, the softening point of the solid aromatic agent resin is in the range of from about 80° C. to about 110° C., more preferably from about 85° C. to about 100° C. Solid aromatic resins not only improve tan δ so that it approaches 1 but, in addition, significantly reduce melt viscosity making processing of the polymer far less difficult.

In preferred embodiments of the sound damping composition, which do not include a solid aromatic resin, the composition comprises from about 50% to about 90% block copolymer and from about 10% to about 50% plasticizer. More preferably, the sound damping composition comprises from about 60% to about 80% of the block copolymer and from about 20% to about 40% plasticizer.

Preferred embodiments of the sound damping composition which additionally include a solid aromatic resin comprise from about 20% to about 60% block copolymer, from about 5% to about 25% plasticizer and from about 30% to about 60% aromatic resin. More preferably, the sound damping composition of this preferred embodiment includes from about 30% to about 40% block copolymer, from about 10% to about 20% plasticizer and from about 10 to about 50% aromatic resin. It is emphasized that all the aforementioned concentrations represent percentages by weight, based on the total weight of the sound damping composition.

In addition to the above essential components, the sound damping composition may be modified further with the addition of other polymers, fillers, reinforcements, antioxidants, stabilizers, fire retardants, anti blocking agents, anti-foggers, pigments, slip agents, nucleating agents, nanocomposites, functionalizing agent, lubricants and other rubber and plastic compounding ingredients without departing from the scope of this invention. Such components are disclosed in various patents including, for example, U.S. Pat. No. 3,239,478 and U.S. Pat. No. 5,777,043, the disclosures of which are incorporated by reference. When one or more of such other components are present in the sound damping compositions of the present invention, they will typically be present in a total amount from about 0.05 weight percent to about 1.5 weight percent based on the total weight percent of the combined components in the sound damping composition.

The sound damping compositions are formulated using techniques well known in the art including, for example, blending of the various components together in a suitable mixer. Molding is achieved utilizing conventional molding processing that is also well known in the art.

### EXAMPLES

The following materials were used in the examples below.

Copolymer 1: An unsaturated block copolymer having a modulus of about 73,000 psi and a polystyrene content of about 75% by weight, commercially available from KRATON Polymers LLC as KRATON® MD6459.

KRATON® 155: Polystyrene-polybutadiene-polystyrene (S—B—S) block copolymer containing 40% S by weight supplied by KRATON Polymers LLC.

Kristalex® 3100: Pure monomer aromatic resin supplied by Eastman, softening point was 100° C.

Wingtack® 86: Aromatic modified aliphatic tackifying resin supplied by Goodyear, softening point was 86° C.

Benzoflex® 131: Isodecyl benzoate supplied by Velsicol.

Santicizer® 160: Butyl benzyl phthalate aromatic ester plasticizer supplied by Ferro.

Shellflex® 371: Paraffinic/naphthenic process oil supplied by Shell.

Irganox® 1010: Phenolic antioxidant supplied by Ciba.

The following test methods were used in the examples below.
Ring & Ball Softening Point according to ASTM D-36. Results are in ° C.
Melt Viscosity measured at 177° C. by ASTM D-3236. Results are in Pa·s.
Dynamic Mechanical Properties were measured with an ARES rheometer in torsional bar mode at a fixed frequency of 1 hertz. Elastic Modulus, G′, and Loss Modulus, G″, were measured over the temperature range of −100 to 150° C. G′ and G″ were used to calculate G* and tan δ and to estimate the upper and lower glass transition temperatures (Tg) of the composition.

The following examples are given to illustrate the invention of the present application. Because these examples are given for illustrative purposes only, the invention should not be deemed limited thereto.

### Example 1

### Compatibility of Block Copolymer 1 with Ester Plasticizers

Copolymer 1 was tested to determine its compatibility with aromatic esters. To that end Benzoflex® 131 and Santicizer® 160 were combined with Copolymer 1 as a solution in toluene and poured into molds. The toluene solvent was driven off to yield 2.5 mm thick dry films which were evaluated qualitatively. The results of this evaluation of 5 compositions prepared in accordance with this example are set forth in Table 1.

TABLE 1

| Component, | Composition | | | | |
|---|---|---|---|---|---|
| % by Wt | A | B | C | D | E |
| Copolymer 1 | 100 | 75 | 50 | 75 | 50 |
| Benzoflex ® 131 | 0 | 25 | 50 | 0 | 0 |
| Santicizer ® 160 | 0 | 0 | 0 | 25 | 50 |
| Appearance¹ | Hard, | Flexible, | Tacky, | Flexible, | Tacky, |
| | Stiff | Strong | transfers | Strong | transfers |

¹Of 2.5 mm thick film.

Results show that both plasticizers have good compatibility with Copolymer 1 but they can be used at no more than about 50% because above about 50%, they soften the polymer excessively.

### Example 2

### Preparation and Evaluation of Sound Damping Compositions

A series of sound damping compositions which included a block polymer of styrene and butadiene were prepared.

As a comparison, the first prepared composition, denoted as CE 1, utilized a styrene-butadiene block copolymer in which the elastomeric block was polybutadiene and the total styrene concentration was 40% by weight.

As a further comparison, a composition, indicated as CE 2, utilized Copolymer 1, a block copolymer within the contemplation of the present invention. However, this composition is outside the scope of the present invention insofar as it does not include any plasticizer.

A third composition, denoted as Composition A, within the scope of the present invention, incorporates Copolymer 1 with a plasticizer, butyl benzyl phthalate.

A fourth composition, designated as Composition B, within the scope of the present invention, includes Copolymer 1, the plasticizer butyl benzyl phthalate and a solid resin which comprises a mixture of aromatic and aliphatic species.

A fifth composition, referred to as CE 3, was very similar to Composition B except that the solid aromatic resin constituency was reduced by 10 wt. % and that 10% by weight was replaced with a paraffinic/naphthenic oil.

Four additional compositions, denoted as Compositions C, D, E and F, all within the scope of the present invention, were prepared. These compositions emulated Composition B in that they included the same constituents, albeit in different concentrations.

The first three discussed compositions, Compositions CE 1, CE 2 and A, were each dissolved in toluene and the solutions cast into films. The remaining six compositions, Compostions CE 3 and B—F, were mixed as hot melts using a sigma blade mixer and pressed into films.

The resultant films were tested to determine their ring and ball softening points and their melt viscosities. In addition, DMA results: elastic modulus, G′; and loss modulus, G″, were determined in accordance with the above description, from which complex modulus, G* and tan δ were calculated in accordance with the above mentioned formulae. Furthermore, observations related to the appearance of the sound damping film compositions were set forth.

The properties of these formulations are summarized in the Table 2 and DMA results are graphically presented in FIGS. 1 to 9. Table 2 presents modulus data for each composition at 25° C. as well as its two glass transition temperatures. FIGS. 1 to 9 present modulus values and resultant calculated tan δ data for a plurality of temperatures that range from as wide a range as −100° C. to 140° C., depending upon the composition.

TABLE 2

| Component, | COMPOSITION NO. | | | | | | | | |
|---|---|---|---|---|---|---|---|---|---|
| % by weight | CE 1 | CE 2 | A | B | CE 3 | C | D | E | F |
| KRATON ® D1155 | 100 | | | | | | | | |
| Copolymer 1 | | 100 | 75 | 40 | 40 | 30 | 40 | 40 | 40 |
| Wingtack ® 86 | | | | 50 | 40 | 50 | 40 | | |
| Kristalex ® 3100 | | | | | | | | 50 | 40 |
| Santicizer ® 160 | | | 25 | 10 | 10 | 20 | 20 | 10 | 20 |
| Shellflex ® 371 | | | | | 10 | | | | |
| Irganox ® 1010 | | | 0.5 | 0.5 | 0.5 | 0.5 | 0.5 | 0.5 | 0.5 |

Physical Properties

| | | | | | | | |
|---|---|---|---|---|---|---|---|
| Ring & Ball Softening | 129 | 124 | 117 | 93 | 112 | 107 | 87 |
| Pt, ° C. | | | | | | | |
| Melt Viscosity @ | 350 | 24 | 14 | 3 | 10 | 45 | 12 |
| 177° C., Pa · s | | | | | | | |

Appearance

| | | | | | | | | | |
|---|---|---|---|---|---|---|---|---|---|
| Color | None | None | None | Lt. | Lt. | Lt. | Lt. | None | None |
| | | | | Yellow | Yellow | Yellow | Yellow | | |
| Clarity | Slight | Clear | Slight | Slight Haze | Very | Hazy | Slight | Clear | Clear |
| | Haze | | Haze | | Hazy | | Haze | | |
| Tack | None | None | Very | Slight | Tacky | Tacky | Slight | None | None |
| | | | Slight | | | | | | |
| Hardness | Flexible | Stiff | Soft | Flexible | Soft | Flexible | Soft | Stiff | Soft |
| Elasticity | Elastic, | Tough | Elastic | Recovers | Elastic, | Little | Recovers | Little | Recovers |
| | snappy | | but not | but not | snappy | recovery | but not | recovery | but not |
| | | | snappy | snappy | | | snappy | | snappy |

DMA Results

| | | | | | | | | | |
|---|---|---|---|---|---|---|---|---|---|
| G′ at 25° C., MPa | 9.5 | 62.0 | 2.2 | 11.6 | 1.1 | 0.5 | 0.7 | 94.5 | 2.3 |
| G″ at 25° C., MPa | 0.8 | 16.0 | 1.1 | 6.6 | 1.1 | 0.3 | 0.4 | 45.9 | 4.1 |
| G* at 25° C., MPa | 9.5 | 64.0 | 2.5 | 13.3 | 1.5 | 0.6 | 0.8 | 105.1 | 4.7 |
| Lower Tg, ° C. | −88 | −30 | −40 | −17 | −27 | −33 | −32 | 5 | −12 |
| Upper Tg, ° C. | 90 | 95 | 121 | 115 | 108 | 73 | 73 | 95 | 75 |

As stated above, dynamic mechanical analysis (DMA) provides a good estimate of a material's effectiveness in damping sound under low strain, oscillatory deformation. Materials that possess good sound damping properties have a relatively high value of tan δ over as broad a frequency range as possible. Since it is much easier to measure modulus properties as a function of temperature, it is that data which is measured. If desired, these tan δ vs. temperature data at a fixed frequency can be converted to tan δ vs. frequency data at a fixed temperature employing the WLF equation, supra.

Analysis of these results begins with an analysis of the sound damping characteristics of Composition CE 1. Composition CE 1 is a conventional block copolymer of styrene-butadiene-styrene. The graph included as FIG. 1 illustrates that after the rubber phase of Composition CE 1 passed through its glass transition temperature (Tg) of −88° C., G′ and G″ were constant over a broad temperature range until the Tg of the end block was reached at 90° C. Tan δ remained at a low value of about 0.1 over most of the temperature (and frequency) range between the two glass transition temperatures. As predicted by an analysis of FIG. 1, the film of Composition CE 1 was flexible but also very elastic and snappy. Composition CE 1 should thus be a very poor sound damping material.

The DMA of Composition CE 2, which included Copolymer 1, a block copolymer within the contemplation of sound damping compositions of the present invention, albeit in the absence of a plasticizer, demonstrated that the polymer, after passing through its lower Tg of −30° C. exhibited a steady drop in G′ and G″ at increasing temperatures until the temperature reached its upper Tg of 95° C. This composition was unacceptable because tan δ was too low. It is, moreover, noted that the melt viscosity was too high for easy processibility.

Composition A demonstrated relatively high tan δ values over a very broad temperature range, and thus a broad frequency range, and is deemed a good sound damping composition albeit it includes only a plasticizer in addition to Copolymer 1.

Composition B, which included both a plasticizer and an aromatic resin, demonstrated relatively high tan δ values over the broadest temperature range of all the compositions tested.

Composition CE 3 represented a composition that differed from Composition B only to the extent that this composition included 10 wt. % of a hydrocarbon oil, which replaced 10 wt. % of the aromatic-modified aliphatic resin. That is, whereas Composition B included 50% by wt. Wingtack®86, Composition CE 3 included only 40% by weight of that component.

Although Composition CE 3 exhibited good tan δ values, those values were not as uniformly high those obtained by Composition B. The result of this comparison suggests that it is not advantageous to include an additional hydrocarbon oil component.

Compositions C to F, which included Copolymer 1, butyl benzyl phthalate plasticizer and an aromatic or aromatic modified resin all demonstrated good tan δ values over a wide temperature range and were each deemed good sound damping compositions.

The above embodiments and examples are given to illustrate the scope and spirit of the present invention. These embodiments and examples will make apparent, to those skilled in the art, other embodiments and examples. These other embodiments and examples are within the contemplation of the present invention. Therefore, the present invention should be limited only by the appended claims.

What is claimed is:

1. A sound damping composition comprising a plasticizer selected from the group consisting of an aromatic ester and a liquid aromatic resin; and at least one unsaturated block copolymer, wherein:
(1) said block copolymer having a mono alkenyl arene content equal to or greater than 60 weight percent, based on the total weight of the block copolymer;
(2) said block copolymer having a modulus less than 125,000 psi; and
(3) said block copolymer comprises at least two A blocks and at least one B block, each A block independently selected from mono alkenyl arene polymer blocks and each B block independently selected from
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution.

2. The sound damping composition of claim 1 further comprising a solid aromatic resin or a solid aromatic-modified aliphatic resin.

3. The sound damping composition of claim 1 wherein said block copolymer is present in a concentration from about 50% to about 90%, and said plasticizer is present in a concentration in a range from about 10% to about 50%, said percentages being by weight based on the total weight of the sound damping composition.

4. The sound damping composition of claim 3 wherein said block copolymer is present in a concentration from about 60% to about 80% and said plasticizer is present in a concentration from about 20% to about 40%.

5. The sound damping composition of claim 2 wherein said block copolymer is present in a concentration from about 20% to about 60%, said plasticizer is present in a concentration in a range from about 5% to about 25% and said solid aromatic or aromatic-modified aliphatic resin is present in a concentration from about 30% to about 60%, said percentages being by weight, based on the total weight of the sound damping composition.

6. The sound damping composition of claim 5 wherein said block copolymer is present in a concentration from about 30% to about 40%; said plasticizer is present in a concentration from about 10% to about 20%; and said aromatic or aromatic-modified aliphatic resin is present in a concentration from about 40% to about 50%.

7. The sound damping composition of claim 1 wherein said plasticizer is an aromatic ester selected from the group consisting of benzoate esters and phthalate esters.

8. The sound damping composition of claim 2 wherein said plasticizer is an aromatic ester-selected from the group consisting of benzoate esters and phthalate esters.

9. The sound damping composition of claim 1 wherein said plasticizer is selected from the group consisting of butyl benzyl phthalate, isodecyl benzoate, 2,2,4-trimethyl pentanediol dibenzoate and a liquid aromatic resin having a softening point of about 5° C.

10. The sound damping composition of claim 1 wherein in each B block, the mono alkenyl arene comprises styrene and the conjugated diene comprises butadiene, isoprene, or mixtures thereof.

11. The sound damping composition of claim 10 wherein each B block has a random distribution.

12. The sound damping composition of claim 10 wherein each B block has a block distribution.

13. The sound damping composition of claim 10 wherein each B block has a tapered distribution.

14. The sound damping composition of claim 10 wherein each B block has a controlled distribution.

15. The sound damping composition of claim 1 wherein said mono alkenyl arene content is from about 60 to about 80 weight percent, based on the total block copolymer.

16. The sound damping composition of claim 1 wherein said block copolymer is linear coupled or multi-arm coupled having symmetrical arms.

17. The sound damping composition of claim 1 wherein said block copolymer is linear coupled or multi-arm coupled having unsymmetrical arms.
